(19) United States
(12) Patent Application Publication
(10) Pub. No.: US 2026/0338285 A1
(43) Pub. Date: Oct. 29, 2026

(54) FLUID PRESSURE-ASSISTED SEAL FOR A DIRECTIONAL CONTROL VALVE AND DIRECTIONAL CONTROL VALVE

(71) Applicant: Woco Industrietechnik GmbH, Bad Soden-Salmuenster (DE)

(72) Inventors: Ralf Möller, Schluechtern (DE); Martin Heldmann, Schluechtern (DE); Markus Führer, Bad Nauheim (DE); Jaroslav Ovesný, Katerinice (CZ)

(73) Assignee: Woco Industrietechnik GmbH, Bad Soden-Salmuenster (DE)

(21) Appl. No.: 19/118,938

(22) PCT Filed: Oct. 17, 2023
(86) PCT No.: PCT/EP2023/078839

§ 371 Date: Apr. 7, 2025

(30) Foreign Application Priority Data
Oct. 17, 2022 (DE) 10 2022 127 145.5

(51) Int. Cl. F16K 11/085; F16K 11/074; F16K 25/00

(52) U.S. Cl. CPC F16K 11/0853; F16K 11/074; F16K 25/00

(57) ABSTRACT

A seal for a directional control valve for adjusting the flow of a fluid, such as a coolant, is described. The seal may form a sealing contact with a housing and a rotary slide arranged in the housing. The seal may have pressure chamber and at least one communication channel for flooding the pressure chamber with the fluid. The pressure chamber may run around a fluid passage opening of the seal, such as running around along the outer contour of the fluid passage opening.

### CROSS REFERENCE TO RELATED APPLICATIONS

This patent application is a U.S. national stage application of PCT/EP2023/078839, filed Oct. 17, 2023, which claims priority to German Patent Application No. 102022127145.5, filed Oct. 17, 2022, each of which is incorporated herein by reference in its entirety.

### BACKGROUND

### Field

The disclosure relates to a seal for forming a sealing contact with a housing and a rotary slide, arranged in the housing, of a directional control valve for adjusting the flow of a fluid, such as a coolant. Furthermore, the disclosure relates to a directional control valve having a seal. Furthermore, the disclosure relates to a motor vehicle fluid flow line system, such as a motor vehicle thermal management system, having a directional control valve. A directional control valve is to be understood as meaning, in particular, a multiway valve.

### Related Art

Generic multiway valves are used, for example, in the motor vehicle for the thermal management thereof and serve, in particular, to conduct coolant, such as water or oils, in order to cool, heat or generally control the temperature of components, in particular in the engine compartment. Such multiway valves are generally equipped with a rotary slide as a valve member, in order to fluidically connect fluid lines connected to the valve to one another or to separate them from one another, depending on the position of the rotary slide. For this purpose, the rotary slide is arranged in a rotatably movable manner in a housing. In order to permit a rotation in the housing, movement play is provided between the rotary slide and the housing, as a result of which an intermediate space is produced between the rotary slide and the housing. In order to prevent leakage via this intermediate space between fluid channels which are separated from one another, seals which seal the fluid lines with respect to the intermediate space are arranged between the rotary slide and the housing.

For a seal which is as reliable as possible, a high contact force which is matched to the acting fluid pressure is required. A high contact force can be achieved, for example, by the use of springs. However, this increases the complexity and therefore the costs and the susceptibility to faults and also the installation space of the directional control valve.

Alternatively, a high contact force can be achieved by seals with a particularly high oversize with respect to the movement play between rotary slide and housing being used. However, this leads to a high expenditure of force during the assembly and operation of the rotary slide.

It is known from WO 2022/025513 to provide this problem by a seal arrangement with a hard and slidable contact surface facing the rotary slide and a soft contact surface facing the housing. As a result, the required assembly force can be reduced on account of a lower frictional resistance between rotary slide and seal along the hard contact surface. Furthermore, during operation, the required torque for adjusting the valve member can be reduced, which reduces the required costs and the required installation space for the servomotor.

However, a disadvantage of this solution is that the different mechanical demands on the two sealing surfaces either require complex two-part structures or production methods which are demanding in terms of process engineering, such as the “two-shot extrusion method” mentioned in WO 2022/025513.

### BRIEF DESCRIPTION OF THE DRAWINGS/FIGURES

The accompanying drawings illustrate the embodiments of the present disclosure and, together with the description, further serve to explain the principles of the embodiments and to enable a person skilled in the pertinent art to make and use the embodiments.

FIG. 1A is a perspective front view of a seal according to one or more exemplary embodiments of the disclosure.

FIG. 1B is a perspective rear view of the seal from FIG. 1A.

FIG. 1C is a perspective side view of the seal from FIG. 1A.

FIG. 2A is a view of a four-way valve according to one or more exemplary embodiments of the disclosure.

FIG. 2B is a side sectional view of the directional control valve according to FIG. 2A.

FIG. 2C is a top sectional view of the four-way valve from FIG. 2A.

FIG. 2D is an enlarged view of the section A from FIG. 2C.

FIG. 2E shows the valve of FIG. 2C with a changed position of the rotary slide, according to one or more exemplary embodiments of the disclosure.

FIG. 2F shows the valve according to FIG. 2E with another changed position of the directional control valve, according to one or more exemplary embodiments of the disclosure.

FIG. 3A is a perspective view of a three-way valve according to one or more exemplary embodiments of the disclosure.

FIG. 3B is a top view of the three-way valve according to FIG. 3A.

FIG. 4A is a perspective view of a rotary slide for a four-way valve according to one or more exemplary embodiments of the disclosure.

FIG. 4B is a top view of a four-way valve with the rotary slide from FIG. 4A.

FIG. 5A is a perspective view of a six-way valve according to one or more exemplary embodiments of the disclosure.

FIG. 5B is a top, sectional view the six-way valve according to FIG. 5A.

FIG. 5C is a top, perspective view from of the six-way valve according to FIG. 5A with cover, according to one or more exemplary embodiments of the disclosure.

FIG. 6A is a perspective front view of an oval seal according to one or more exemplary embodiments of the disclosure.

FIG. 6B is a perspective rear view of the seal according to FIG. 6A.

FIG. 7A is a front view of an end face seal according to one or more exemplary embodiments of the disclosure.

FIG. 7B is a rear view of the seal according to FIG. 7A.

FIG. 8A is a perspective side view of a four-way valve according to one or more exemplary embodiments of the disclosure with a seal according to FIG. 7A.

FIG. 8B is a sectional view of the four-way valve according to FIG. 8A.

FIG. 8C is a sectional view of the four-way valve according to FIG. 8A.

FIG. 8D is an enlarged, partial view of a region from FIG. 8C.

FIG. 9A is a side view of a seal according to one or more exemplary embodiments of the disclosure.

FIG. 9B is a side sectional view of the seal according to FIG. 9A.

The exemplary embodiments of the present disclosure will be described with reference to the accompanying drawings. Elements, features and components that are identical, functionally identical and have the same effect are-insofar as is not stated otherwise respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

An object of the present disclosure is to overcome the disadvantages of the prior art, in particular to provide a seal for a directional control valve and a directional control valve, with which the seal between rotary slide and housing can be increased without increasing the complexity of the rotary slide and/or the expenditure of force for the assembly and operation.

One aspect of the disclosure relates to a seal for forming a sealing contact with a housing and a rotary slide, arranged in the housing, of a directional control valve for adjusting the flow of a fluid, such as a coolant. The seal has a pressure chamber and at least one communication channel for flooding the pressure chamber with the fluid. The seal may be designed to form such a sealing contact with the housing and the rotary slide in such a way that a fluid line connected to the housing can be sealed off from an intermediate space between the rotary slide and the housing by means of the seal. In particular, the seal is designed to reduce, or prevent, a fluid flow from the intermediate space into the fluid line and vice versa in a closed state of the rotary slide in relation to the fluid line. For this purpose, the seal may include a fluid passage opening which is completely surrounded by a sealing body of the seal. The sealing body can comprise, in particular, the pressure chamber described below, the inner limb, the outer limb, supporting ribs and/or the base of the seal. The sealing body may include elastic, in particular elastomeric, material and is formed, in particular, completely therefrom.

The fluid passage opening may include a diameter of at least 4 mm, preferably at least 8 mm, particularly preferably at least 12 mm, at least 16 mm, at least 20 mm, at least 24 mm or at least 30 mm. However, the fluid passage opening does not necessarily have to be circular. It can also have, for example, an oval shape. In this case, the oval shape can have semicircular sections, preferably with predefined diameters, and a rectangular section connecting the semicircular sections. The length (distance between the semicircular sections) of the rectangular section can preferably be at least 3 mm, particularly preferably at least 5 mm, 10 mm or 15 mm. The width of the rectangular section (length) can preferably have the same minimum dimensions as the diameter described above, particularly preferably the same width as the diameter. A further embodiment of the passage opening can be a disc-section-shaped passage opening. In the end face embodiments described in detail below, the seal can have a plurality of passage openings, for example at least two, three, four, five or six passage openings. In this embodiment, the seal can be circular, for example, wherein the plurality of passage openings are separated from one another in the circumferential direction by sealing material of the seal.

The pressure chamber can be formed by a groove, in particular a v-shaped groove, introduced into the sealing material of the seal. The pressure chamber, in particular groove, may run around the fluid passage opening completely. Apart from the communication channel, the pressure chamber can be enclosed completely or in sections by the sealing material of the seal. The pressure chamber may be introduced into the seal in such a way that, in the assembled state, in particular apart from the at least one communication channel, it is completely enclosed by the sealing material and the housing. In particular, the pressure chamber can have an opening, in particular an annular opening, on its side facing the housing, which opening can be closed by the housing in the assembled state, in order to completely enclose the pressure chamber, in particular apart from the at least one communication channel.

By flooding the pressure chamber via the at least one communication channel, the fluid pressure can be used to provide, in particular to intensify, the contact force between the seal and the rotary slide and the housing. The seal is designed in particular in such a way that the pressure chamber is pressed against the rotary slide and/or the housing as a result of the flooding with the fluid. In particular, the seal is designed in such a way that the pressure chamber is inflated, in particular in a balloon-like manner, by the flooding with the fluid. As a result of the inflation of the pressure chamber, the latter is compressed between rotary slide and housing, with the result that elastic restoring forces of the sealing material which may be produced in the process increase the contact force, as a result of which the seal is increased.

The inventors have recognized that, by means of the principle according to the disclosure of the pressure chamber with a communication channel, the fluid pressure can be used to provide self-intensification of the contact force. As a result, firstly the oversize between seal and movement play between rotary slide and housing can be reduced, which requires lower forces for the assembly of the seal. During operation, the fluid pressure is then used to increase the contact force in such a way that leakage is reduced, in particular avoided. In this case, it has proven to be particularly advantageous that, in the case of a relatively high fluid pressure, the contact force is also automatically increased. As a result, the seal according to the disclosure can be used for different pressure conditions and provides the required contact pressure at any time. As a result, the fluid pressure itself ensures an adequate contact force which is matched to the fluid pressure. As a result, it can be avoided, in particular, that unnecessarily high contact forces prevail in the case of low fluid pressures or excessively low contact forces prevail in the case of high fluid pressures. As a result, the drive power of the motors for the rotary slide can also be individually matched to the pressure conditions.

The inventors have furthermore established that, as a result of the fluid pressure-assisted contact force, contact means such as springs can be dispensed with and leakage can nevertheless be reliably avoided. The seal can therefore preferably be used in directional control valves without separate contact means such as springs. The directional control valves described below are therefore particularly preferably directional control valves which are free from contact means, such as springs, which are present in addition to the elastic material of the seal.

As described above, the pressure chamber may be formed by a groove, in particular a v-shaped groove, introduced into the sealing material of the seal. The formation of the pressure chamber by means of a groove reduces the deformation resistance of the seal. As a result, in the case of a constant fluid pressure, a relatively large deformation, in particular inflation, of the pressure chamber can be achieved, which in turn increases the contact force. The inflation may take place by means of an overpressure in the pressure chamber. This can be achieved, for example, by virtue of the valve housing being flooded, which in turn supplies the pressure chamber with fluid via the communication channels, whereas a line to be closed has a lower pressure, with the result that an overpressure which inflates the seal prevails in the pressure chamber. However, even in embodiments and/or operating states in which an overpressure acts on the pressure chamber from the outside, for example when a fluid-conducting line to be closed has a higher pressure than the flooded housing, the reduced deformation resistance of the seal by means of the groove-shaped pressure chamber is advantageous since, as a result, compression of the seal is intensified, as a result of which the contact force between the seal and the rotary slide and the housing can likewise be intensified. The increased tightness with respect to such operating states by means of the groove-shaped pressure chamber can also be referred to as reverse flow resistance.

The seal may be designed to surround a fluid passage opening of the housing and, in a position of the rotary slide closing the fluid passage opening, to seal off an intermediate space between the rotary slide and the housing with respect to the fluid passage opening. In this case, the seal can be designed to intensify the contact force with respect to the housing and/or the valve member when a higher pressure acts on the seal from the intermediate space than from the fluid passage opening, in particular from a fluid line connected to the latter (higher internal pressure) and/or when a higher pressure acts on the seal from the fluid passage opening, in particular from a fluid line connected to the latter, than from the intermediate space (higher external pressure). The seal may be designed to increase the contact force both in the case of a higher external pressure and in the case of a higher internal pressure. The pressure chamber may be designed to be flooded, in particular by means of the at least one communication channel, via the intermediate space between the housing and the rotary slide. The increase in the contact force in the case of a higher internal pressure is achieved by flooding the pressure chamber with the higher pressure, in particular as a result of which the seal is inflated in a balloon-like manner, in particular as described above and below. Alternatively, or additionally, the intensification of the contact force in the case of a higher external pressure is achieved by deforming, in particular compressing, the seal in such a way that the seal is pressed in the radial direction (with respect to the axis of rotation of the rotary slide) against rotary slide and/or housing, in particular as a result of compression in the circumferential direction (with respect to the axis of rotation of the rotary slide).

A further advantage of the flooding of the pressure chamber is that, in the case of flooded valve housings, a part of the pressure which acts on the seal from the fluid housing and forces the latter in the direction of the fluid line is compensated for by the pressure prevailing in the pressure chamber. As a result, the risk of the seal slipping into the fluid line can also be reduced, which can lead to faults and leakage. This problem occurs, in particular, in operating states in which the pressure in the housing is higher than in the line to be sealed. For example, in the case of a fluid pressure of 3 bar in the housing and of 1.5 bar in the line to be sealed, there is an increased risk in the case of conventional systems that the seal is pressed into the line. This problem could be satisfactorily solved by the solution according to the disclosure of the flooding of the pressure chamber which compensates for a part of the pressure acting on the seal from the housing by the pressure acting in the pressure chamber.

A further advantage of the self-intensifying seal according to the disclosure as a result of the flooding of the channel is that the valve drive can be designed to be smaller than in the case of conventional systems, since a lower torque is required for the adjustment as long as the contact force is not increased by the fluid pressure. For example, during the adjustment of the rotary slide, transitional states occur in which both the line and the housing are flooded, with the result that the fluid pressure in the pressure chamber is compensated for by the pressure acting on the pressure chamber from the outside. As a result, an adjustment of the rotary slide with a low torque can be achieved. As soon as the rotary slide is in its final position, in which in turn a line is sealed off, the pressure in this line drops, with the result that an overpressure is produced again in the pressure chamber and the self-intensifying effect of the seal is produced again.

The pressure chamber may run around a fluid passage opening of the seal. The fluid passage opening can in principle assume any size and/or shape. For an exemplary use described below in motor vehicle fluid flow guiding systems, such as motor vehicle thermal management fluid guiding systems, in particular motor vehicle cooling circuits, in particular a circular, oval or disc-section-shaped shape and the dimensions described above have proven to be advantageous as the shape of the fluid passage opening.

The pressure chamber may run around the fluid passage opening along the outer contour thereof. The pressure chamber may be formed by a groove, in particular a v-shaped groove, running around the fluid passage opening. The pressure chamber, in particular the groove, may taper from a side of the seal facing the housing to a side of the seal facing the rotary slide. The pressure chamber may be bounded by an inner limb facing the fluid passage opening and an outer limb facing away from the fluid passage opening. The inner limb and the outer limb may run around the fluid passage opening completely, in particular the inner limb runs around along the outer contour of the fluid passage opening, and the outer limb may run through the pressure chamber at a distance along a contour correspondingly adapted to the contour of the inner limb. The inner limb and the outer limb may run towards one another in the side facing the rotary slide, in particular in the radial direction with respect to the axis of rotation of the rotary slide, the tip in which the inner limb and the outer limb run together may form an inner sealing surface facing the rotary slide, which inner sealing surface may form a sealing contact between rotary slide and seal in the mounted state. The inner sealing limb and the outer sealing limb may be spread over a spreading angle extending in the circumferential direction with respect to the axis of rotation of the rotary slide, in particular extend away from one another in the radial direction with respect to the axis of rotation of the rotary slide, in particular in opposite circumferential directions with respect to the axis of rotation of the rotary slide. In particular by means of the above-described v-shaped profile of the inner and outer sealing limb in the radial direction, it can be ensured that an increase in the contact force of the seal with respect to the rotary slide and/or the housing is provided both in the case of a higher internal pressure and in the case of an increased external pressure. In particular, the inner limb and the outer limb run towards one another in a v-shaped manner. The inner limb and the outer limb may merge into one another on the side facing the rotary slide and are spaced apart from one another on the side facing the housing. The in particular groove-shaped pressure chamber may extend between the inner limb and the outer limb. The inner limb and the outer limb may be designed to bear sealingly against a housing of a rotary slide in the mounted state, with the result that, apart from the at least one communication channel, the pressure chamber is enclosed by the seal and the housing. The inner sealing limb and the outer sealing limb may be configured to extend in the radial direction, in particular to widen towards the housing, and/or to form a sealing contact on the housing with a surface of the housing extending parallel to the outer contour of the rotary slide. In particular, the inner sealing limb and the outer sealing limb each have an outer sealing surface which faces the housing and which may run parallel to the outer contour of the rotary slide, in particular is curved in such a manner that they can be placed against a surface of the housing which curves in the circumferential direction around the rotary slide.

The inventors have recognized that, by means of the tapering, in particular v-shaped tapering, of the pressure chamber, in particular by means of the above-described inner and outer limbs, a self-intensifying sealing effect is produced even in the case of an overpressure acting on the pressure chamber from the outside (in relation to the internal pressure in the chamber), specifically by virtue of the fact that the inner and outer limbs which face the housing and are spaced apart from one another are compressed by the overpressure and thereby intensify the contact force between seal and housing and between seal and rotary slide.

The inner limb may include an outer sealing surface facing the housing and an inner sealing surface facing the rotary slide to form the sealing contact, wherein the inner sealing surface and/or the outer sealing surface may run around the fluid passage opening. The inner sealing surface and the outer sealing surface may run around the fluid passage opening without interruption. This is to be understood as meaning, in particular, that the inner sealing surface and the outer sealing surface are designed to form, in the assembled state, a sealing contact which runs around the fluid passage opening uninterruptedly with the rotary slide or with the housing, in particular in such a manner that fluid passage along the outer sealing surface and the inner sealing surface is avoided.

The at least one communication channel may be connected to the pressure chamber via the outer limb. The seal may include at least two, three, four, five or six communication channels. The communication channels may be connected to the pressure chamber via the outer limb. The communication channels may be arranged distributed in the circumferential direction around the fluid passage opening, in particular arranged at equidistant distances from one another. A communication opening may be provided in the outer limb to form the at least one communication channel. The communication opening can be designed as a cutout in a sealing surface of the outer limb facing the housing. In such an embodiment, the communication opening is bounded, in the assembled state, firstly by the outer limb and secondly by the housing. As is described in detail below, the communication channel furthermore may extend between a base of the seal, which base is to be placed on the housing, and the housing. In an alternative embodiment, however, the communication channel can also be formed by an opening, in particular channel, which is completely enclosed by the outer limb.

The seal may include a foot to be placed on the housing with an effective surface facing the rotary slide, in order to press the foot against the housing via fluid pressure acting on the effective surface when the housing is flooded with the fluid, in particular to provide a contact pressure between the foot and the housing counteracting a relative movement between the seal and the housing. As a result, the contact force against the housing can be increased and the risk of the seal slipping can thus be further avoided. The foot may run around the fluid passage opening completely. In the embodiments described in detail below with a plurality of fluid passage openings in a seal, the foot may run around all the fluid passage openings. The foot may extend, starting from the outer limb, in the circumferential direction, with respect to the axis of rotation of the rotary slide, at least by 50%, 100%, 150% or 200% of the extent of the outer limb in the circumferential direction. Alternatively, or additionally, the foot has, with respect to pressure acting from the intermediate space between rotary slide and housing, a pressure-effective area which corresponds to at least 50%, 100%, 150% or 200% of the pressure-effective area of the inner limb and/or outer limb of the seal. The foot may extend parallel to the outer contour of the rotary slide and/or of the housing. In particular, as a result of the above-described large pressure-effective area and geometry of the seal, sliding of the seal relative to the housing and thus leaks associated therewith can be avoided.

The foot may adjoin the above-described outer limb. The foot particularly may adjoin the end of the outer limb facing the housing. The foot may be matched to the shape of the housing. In particular, the foot, the outer limb and the inner limb can together form a curved bearing surface for bearing against the housing. The curved bearing surface can be interrupted, in particular exclusively, by the fluid passage opening, the pressure chamber and, if appropriate, the at least one communication channel. As a result, a large bearing surface can be formed via which the foot can be pressed against the housing via the fluid pressure in order to prevent slipping and/or sliding of the seal.

The communication channel may extend between the foot and the housing in the assembled state. The at least one communication channel may include a groove formed in the foot, which groove fluidically connects an intermediate space between the housing and the rotary slide to the pressure chamber. In the case of a plurality of communication channels, the latter may be arranged distributed in the circumferential direction around the fluid passage opening, in particular distributed at equidistant distances in the circumferential direction around the latter.

The seal may include an outer sealing surface facing the housing and an inner sealing surface facing the rotary slide to form the sealing contact, which are formed from the same material. In the assembled state of the seal, the sealing surfaces in contact with the rotary slide and with the housing, in particular the outer sealing surface and the inner sealing surface of the seal, may be produced from the same material, in particular produced in one piece. The material may be an elastomer material. The entire seal may be formed from the same material, in particular elastomer material. The inner sealing surface and outer sealing surface may be formed by the pressure of the above-described inner limb. The above-described inner sealing limb and outer sealing limb may form a v-shaped structure which runs around the fluid passage opening. The pressure chamber may be formed between the inner sealing limb and the outer sealing limb. In particular, the outer limb and the inner limb merge into the inner sealing surface on the side of the seal facing the rotary slide. Communication openings may be provided on the side of the outer limb facing the housing, for example cutouts which form part of the communication channel or completely form the communication channel.

The seal may include at least one support rib arranged in the pressure chamber, in particular to stabilize the pressure chamber against pressure acting on the pressure chamber from outside the pressure chamber, wherein the at least one support rib may extend between the inner limb and the outer limb. The seal may include a plurality of support ribs, such as at least 2, 3, 4, 5, 6, 7, 8, 9, 10, 11, 12, 13, 14, 15 or 16 support ribs. The support ribs may be arranged, viewed circumferentially, around the fluid passage opening, in particular at equidistant distances, within the fluid chamber. The support ribs may divide the pressure chamber into a plurality of chamber sections. The support ribs may extend from the side of the seal facing the rotary slide, in particular between the inner limb and the outer limb, to the side of the seal facing the housing. The support ribs may be designed in such a way that a fluidic connection between the chamber sections formed by the support ribs is made possible. For this purpose, the support ribs may be configured so as to not extend completely as far as the outer sealing surface in order to make possible, between the support ribs and the housing, a communication opening for exchanging fluids between the chamber sections of the pressure chambers. In alternative embodiments, however, communication openings can also be formed in the support ribs in order to make possible a fluidic communication between the chamber sections of the pressure chamber. The inventors have established that the support ribs counteract collapsing of the seal as a result of a pressure acting on the pressure chamber from the outside. As a result, the reliability of the seal can once again be increased. In particular, it can be avoided by the support ribs that the seal is compressed to such a great extent in the case of a higher external pressure that fluid overcomes a sealing contact between the seal and the rotary slide and/or the housing and as a result leads to leakage.

The at least one communication channel may be designed to connect the pressure chamber fluidically to the intermediate space between housing and rotary slide of the directional control valve. For this purpose, the seal may include, on a side facing the intermediate space, at least one, preferably a plurality of, communication opening(s) via which fluid can penetrate from the intermediate space into the communication channel and can pass via the communication channel into the pressure chamber. For this purpose, at least one groove which forms the at least one communication channel may be made in the outer limb facing away from the fluid passage opening. A plurality of grooves which each form a communication channel may be provided. The at least one groove may be made on the side of the outer limb facing the housing, in particular in such a way that, in the assembled state, the outer limb runs around the communication channel completely together with the housing. In alternative embodiments, the communication channel can be formed as a hole in the seal, in particular in the outer limb of the seal, which hole is completely surrounded by sealing material of the seal. The groove may be made not only in the outer limb but additionally also in the above-described foot, with the result that the communication channel extends along the outer limb and the foot. The foot may adjoin the end of the outer limb facing the housing in a planar, in particular disk-shaped, manner and extends in the direction opposite the fluid passage opening. The outer limb and the foot may form an L-shape in cross section, of which one limb forms the outer limb and the other limb forms the foot. In this case, one limb may extend toward the rotary slide and the other limb, in particular inclined by at least 10°, 20°, 30°, 40°, 50°, 60°, 70°, 80°, 90°, 100°, 110° or 120° with respect to the first limb, extends away from the fluid passage opening. The inner limb particularly may adjoin the outer limb of the above-described L in cross section and forms with the latter a v shape widening toward the housing.

In one embodiment, the fluid passage opening is of circular design. In this embodiment, the pressure chamber may extend annularly around the fluid passage opening. In this case, the pressure chamber may be formed as an annular groove which may taper in a V shape toward the side facing the rotary slide. In this embodiment, the seal may include a sealing surface which has an uninterrupted annular shape and faces the housing. The sealing surface may be designed like the above-described inner sealing surface. In addition, the seal may include an outer sealing surface facing the rotary slide, which may extend annularly around the fluid passage opening uninterruptedly. The inner sealing surface and the outer sealing surface may be formed by the above-described inner limb, in particular connected to one another. This outer sealing surface and/or the inner sealing surface may extend on the side of the seal facing the fluid passage opening, in particular the pressure chamber.

In addition, the seal may include a sealing surface (interrupted sealing surface) which is interrupted in sections in the circumferential direction and is in particular annular and faces the housing. The interrupted sealing surface is interrupted in particular by the at least one above-described communication channel, such as by a multiplicity of communication channels which may be spaced apart from one another in the circumferential direction, in particular spaced apart from one another at equidistant distances. This interrupted sealing surface may be formed on the end of the above-described outer limb facing the housing. The outer limb particularly may run in the axial direction (with respect to the axis of symmetry of the circular fluid passage opening) towards the inner limb, in particular in such a way that the inner limb and the outer limb form a v-shaped structure.

The above-described foot may adjoin the interrupted annular sealing surface, which foot in particular extends outwards in the radial direction with respect to the fluid passage opening, and in particular extends the at least one communication channel along the foot. The at least one communication channel in particular extends completely through the foot into the pressure chamber, with the result that fluid can pass from the outside in the radial direction via the foot through the at least one communication channel into the pressure chamber. The foot may run around the pressure chamber, and in particular the outer limb, completely in the circumferential direction. The foot can in particular be of planar form.

In an alternative embodiment, the fluid passage opening is of oval form. In this embodiment, the seal may be designed as described above for the embodiment with a circular fluid passage opening, with the sole exception that the structures described as annular are of oval form, in particular the pressure chamber, the inner sealing surface, the outer sealing surface and the sealing surface which is interrupted in sections are of oval form.

In a further embodiment, the seal may include at least two, such as at least three, fluid passage openings. In this case, the fluid passage openings can have a common throughflow direction. In the case of symmetrical fluid passage openings, the throughflow direction can be defined by the axis of symmetry, in particular run parallel to the axis of symmetry. In the case of non-symmetrical fluid passage openings, the common throughflow direction can be defined by the normal of the passage opening. In an embodiment with at least two fluid passage openings, these can be arranged offset with respect to one another in the circumferential direction with respect to the throughflow direction. In particular, in such an embodiment, the seal can have a central axis about which the at least two fluid passage openings are arranged offset. For example, the at least two, such as at least three, fluid passage openings can be of disc-section-shaped form. In an embodiment with a plurality of fluid passage openings, the seal may include a dedicated pressure chamber for each seal. Each of the pressure chambers may run around in each case one of the fluid passage openings. Each of the pressure chambers may include at least one, such as a plurality of, communication channels in order to flood the pressure chamber with the fluid. Communication channels which fluidically connect each of the pressure chambers to the intermediate space between housing and rotary slide are provided. Alternatively, or additionally, communication channels which fluidically connect the pressure chambers to one another can be provided. In an exemplary embodiment, the seal is of disk-shaped form and has at least two, such as at least three, fluid passage openings which are arranged in the circumferential direction around the axis of symmetry of the disk. In this embodiment, communication channels which connect the pressure chamber to the outside in the radial direction to the intermediate space and/or communication channels which connect the pressure chambers to one another, in particular in the circumferential direction, are provided. In such embodiments, the above-described foot can simultaneously form in each case one connecting structure, in particular in each case one web, between the individual fluid passage openings and pressure chambers, which connecting structure may be interrupted, in particular exclusively, by the communication channels, in particular in the form of grooves.

The disclosure furthermore relates to a directional control valve for adjusting the flow of a fluid, such as a coolant. The directional control valve may be a multiway valve, such as a directional control valve with at least three ways, four ways, five ways, six ways or seven ways. The directional control valve has a housing with at least one fluid passage opening, a fluid line connected to the fluid passage opening and a rotary slide arranged in the housing. The directional control valve furthermore has a seal according to the disclosure which is in sealing contact with the housing and the rotary slide and surrounds the fluid passage opening. The above-described fluid passage opening of the seal may be aligned with the fluid passage opening of the fluid line. The geometry and the size of the fluid passage opening of the seal may correspond substantially to the size and geometry of the fluid passage opening of the fluid line. Substantially are to be understood as meaning, with regard to the size, in particular deviations of the cross section of at most +/−40%, 30%, 20%, 10%, 5%, 3% or 1%. However, the fluid passage opening of the seal may be at least as large as the fluid passage opening of the fluid line, in order to avoid a narrowing of the through-flow cross section through the seal. The hydraulic cross section of the fluid passage opening in the housing, in the fluid line connected thereto, in the seal and in the rotary slide may be substantially equal in size. The hydraulic cross section of fluid flowing through the directional control valve, in particular between at least two fluid lines connected to fluid passage openings of the housing, may be substantially constant.

The housing may include a plurality of fluid passage openings, such as at least two, at least three, at least four, at least five or at least six fluid passage openings. A fluid line may be connected to each of the fluid passage openings. The housing can be cylindrical. The fluid passage openings can be introduced into the casing of the housing, in particular introduced into the casing of the housing offset with respect to one another in the circumferential direction. Alternatively, or additionally, one or more fluid passage opening(s) can be attached to one or both end sides of the housing.

A seal, in particular according to the disclosure, can be arranged in each case between the housing and the rotary slide at a plurality of fluid passage openings, such as at each of the fluid passage openings formed in the casing and/or the end side of the housing. The rotary slide may be designed to produce and/or prevent, depending on the position, a fluidic connection between at least two, three or more fluid lines. For this purpose, the rotary slide can have a fluid passage opening which, depending on the position of the rotary slide, can produce a fluidic connection between at least two or at least three fluid lines. The rotary slide can furthermore have blocking sections with which it can close off fluid lines with respect to other fluid lines. The rotary slide may be of cylindrical form. In this case, the fluid passage opening can be designed as a cutout in the cylinder. The outer diameter of the rotary slide may be smaller than the inner diameter of the housing. As a result, a movement play between rotary slide and housing is provided. The seal or seals is/are arranged in this movement play. In particular, the seal is designed to be larger in the axial direction (the direction in which the fluid passage opening of the seal is flowed through in an open position) than the movement play. As a result, the seal is compressed between the rotary slide and the housing in the assembled state, as a result of which a contact force is provided. The above-described outer sealing surface of a seal may run around the respective fluid passage opening of the housing completely. The above-described inner sealing surface may form a surrounding sealing contact with the rotary slide in the blocked state of the fluid line. As described above, the inner sealing surface and the outer sealing surface may be formed by the inner limb of the seal which runs around the fluid passage opening of the seal. The communication channel may be furthermore connected to the pressure chamber via the outer limb.

The outer limb may extend from the inner sealing surface to the housing. The outer limb may form with the housing a sealing surface which is interrupted by the communication channels but otherwise runs around. In this case, the at least one communication channel may be bounded firstly by the outer limb and secondly by the housing. As described above, a foot of the seal adjoins the end of the outer limb facing the housing, which foot extends in the direction opposite the fluid passage opening (in particular extends outwards in the radial direction with respect to the fluid passage opening). The communication channel may extend through the foot and has a communication opening opposite the intermediate space between the housing and the rotary slide. Fluid can thereby flow out of the intermediate space between rotary slide and housing via the communication channel into the pressure chamber. The directional control valve may be designed in such a way that the intermediate space is always flooded during operation. It is thereby ensured in every operating state that the pressure chamber can be flooded with fluid. If the rotary slide closes a fluid passage opening in the housing with its blocking section, the pressure in the fluid line connected to the fluid passage opening can thereby drop, for example if fluid no longer flows through the fluid line or fluid is no longer present. As a result, a lower pressure acts on the seal via the inner limb of the seal facing the fluid line than via the flooded pressure chamber. The pressure chamber is thereby inflated, as a result of which the seal is pressed more strongly against the rotary slide and the housing, which in turn increases the contact force and thus the tightness. A self-intensifying seal is thereby provided.

The inventors have established that the self-intensification of the seal functions particularly well if the directional control valve, in particular the flooded region between the housing and the rotary slide, is free from air inclusions. Cavitation, in particular, can thereby be avoided and reliable heat transport by the fluid can be ensured. A system comprising a directional control valve and an equalization container may be provided for this purpose, such that air remaining in the valve can be collected in the equalization container or can be removed from the directional control valve by applying negative pressure.

The inner limb and the outer limb can be of approximately equal length. In other words, the inner limb and the outer limb can protrude approximately equally far in the fluid passage direction. In an alternative embodiment, the inner limb can be longer than the outer limb. In this embodiment, a groove which may be annular or oval, in particular to the shape of the inner limb, can be formed in the housing, in which groove the inner limb can be received in an accurately fitting manner in the mounted state of the seal 1. The inner limb can be received in the groove in particular via a “tongue-and-groove” principle. In this embodiment, the seal can provide improved seal in both directions of action of the pressure.

further aspect of the disclosure relates to a directional control valve, which can be designed in particular like the above-described directional control valve, for adjusting the flow of a fluid, such as a coolant. The directional control valve may comprise a housing with a fluid passage opening, a fluid line connected to the fluid passage opening, a rotary slide arranged in the housing, and a seal which is in sealing contact with the housing and the rotary slide and surrounds the fluid passage opening. According to the above-described aspect of the disclosure, the seal can be designed in particular with a pressure chamber and a communication channel. According to this aspect of the disclosure, a support structure which counteracts slipping of the seal into the fluid passage opening is provided in the connection region between the fluid passage opening of the housing and the fluid line. The support structure can run around the fluid passage opening of the housing in the form of a collar. In particular, the support structure can have an annular shape, in particular a hollow cylindrical shape, which may include the same diameter as the fluid passage opening. The support structure may be formed in one piece with the housing. The housing may include a substantially cylindrical inner surface which is interrupted by the fluid passage opening. Starting from the cylindrical inner surface, the support structure may project into the housing. The support structure may be matched to the shape of the fluid passage opening in the housing. In particular, the shape of the support structure corresponds to the shape of the outer contour of the fluid passage opening. For example, in the case of a circular fluid passage opening, the support structure may be of annular form. In the case of an oval fluid passage opening, the support structure may be of oval form.

The seal may bear against the support structure. In particular, the side of the seal facing the fluid passage opening bears against the support structure. The seal may be matched to the shape of the support structure in the region in which it is in contact with the support structure. The seal may run around the support structure completely. The above-described inner limb of the seal particularly may bear against the support structure. In particular, the inner limb and the outer limb, in particular as described above, run apart from one another in the direction of the housing, in particular in the radial direction, a region which extends from the spread end of the outer limb in the radial direction towards the rotary slide being in contact with the support structure. The inner limb particularly may bear against the support structure over at least 10%, 20% or 30% of its extent, in particular starting from the housing in the radial direction towards the rotary slide, between the above-described inner sealing surface and the outer sealing surface. The support structure and the seal may be matched to one another according to the tongue-and-groove principle, in order to avoid slipping of the seal into the fluid passage opening. The seal may include, starting from the inner limb, a projection, in particular a circumferential projection, which projects towards the fluid passage opening and may rest on the support structure. The projection and the section bearing against the support structure particularly may form an L shape in cross section. The projection may include an inner contour facing the fluid passage opening, which inner contour may correspond in shape and/or dimension to the fluid passage opening of the housing and the support structure.

The directional control valve may include, in addition to the above-described support structure, which can also be described as an inner support structure, an outer support structure on which an end of the seal facing away from the fluid passage opening, in particular one of the above-described outer limbs and/or the above-described foot, is supported. The outer support structure can have a web extending inwards starting from the cylindrical inner surface of the housing. The web can in particular extend inwards in the radial direction into the housing. The web can particularly be of T-shaped design. As a result, a recess can be formed, in particular between the roof of the T and the cylindrical inner surface of the housing, into which recess the outer limb, such as the above-described foot of the seal, can engage. The inventors have recognized that, in particular by means of the combination of the inner and outer support structures, it can be ensured that expansion of the seal, as a result of the flooding of the pressure chamber with fluid, is limited or prevented in the radial direction (or towards or away from the fluid passage opening). The expansion of the pressure chamber can thereby take place, in particular, in the form of an expansion in the throughflow direction, with the result that the expansion is used to increase the contact force on the rotary slide and the housing and thus intensify the sealing contact. The outer support structure may be formed by a recess in the housing, in particular a depression, such as an undercut in the housing. The depression may be designed to receive the above-described foot, in particular in such a way that the foot projects into the depression. In this case, the depression may be of larger design than the foot, with the result that fluid can flow around the foot along an intermediate space between the foot and the depression, in particular along the contour of the depression from a side of the foot facing the rotary slide to a side of the foot facing the housing, through which at least one communication channel can flow.

The directional control valve may be designed to flood the housing, in particular an intermediate space between the housing and the directional control valve. This can be realized, for example, by the rotary slide having at least one fluid passage opening via which the fluid can flow into and out of the rotary slide, wherein the fluid passage opening of the rotary slide may be larger than the fluid passage opening of the housing and/or of the seal. It can thereby be ensured that, even with perfect centering of the fluid passage opening of the rotary slide on that of the housing and of the seal, a bypass channel always remains via which, in addition to a primary fluid flow (between at least two fluid lines), a secondary fluid flow (into the intermediate space between housing and rotary slide) is permitted. This secondary fluid flow floods the intermediate space and thus the pressure chambers via the intermediate space, as a result of which the self-intensifying seal is provided.

In embodiments in which the fluid passage openings of the housing are formed in the cylinder shell of the housing, the fluid passage opening of the rotary slide can be dimensioned so large in the circumferential direction that two fluid passage openings of the housing lying next to one another in the circumferential direction can be connected to one another. For example, in embodiments in which the fluid passage openings of the housing are spaced apart from one another by 30° in the circumferential direction, the fluid passage opening in the rotary slide can extend over at least 90°, with the result that 30° can be used to bridge the distance between the two openings and in each case 30° for each opening, in order to provide an overlapping through-flow cross section with the respective lines. For this purpose, the rotary slide can have, for example, a cylindrical basic shape in which the fluid passage opening is designed as a disc-section-shaped cutout. The fluid passage opening may be designed in such a way that it can be brought into fluidic connection with the fluid passage openings of the housing via the cylinder shell.

In end face embodiments, the rotary slide can be designed as an in particular circular disk which has fluid passage openings which are continuous in the axial direction. Here too, the fluid passage openings in the rotary slide may be designed to be larger than the fluid passage openings in the housing, in order to provide flooding of the intermediate space between housing and rotary slide.

The disclosure furthermore relates to a motor vehicle fluid flow guiding system, in particular a motor vehicle thermal management fluid guiding system, such as a motor vehicle cooling circuit, which has a directional control valve according to one or both of the aspects of the disclosure described above.

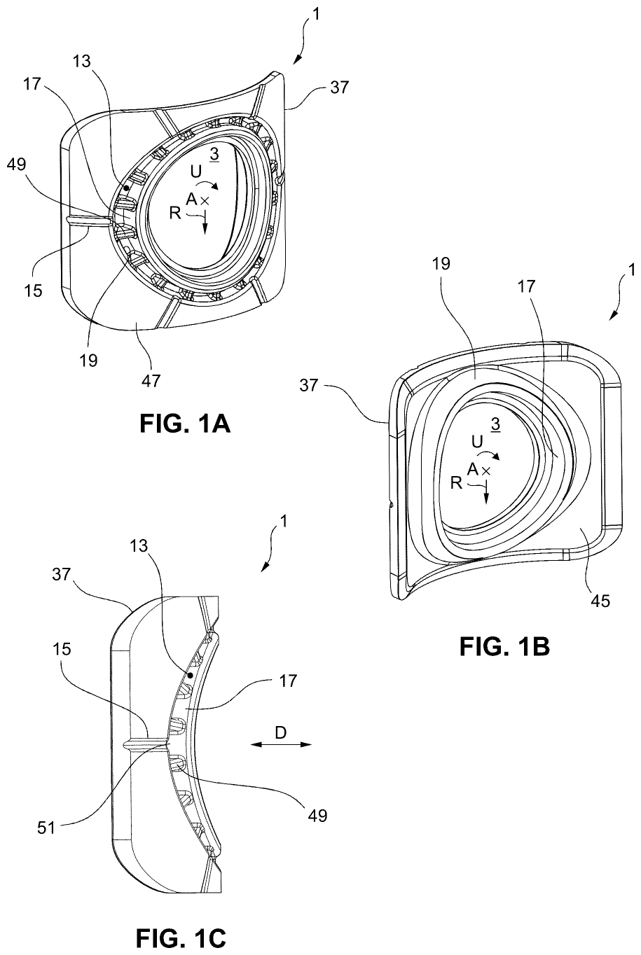

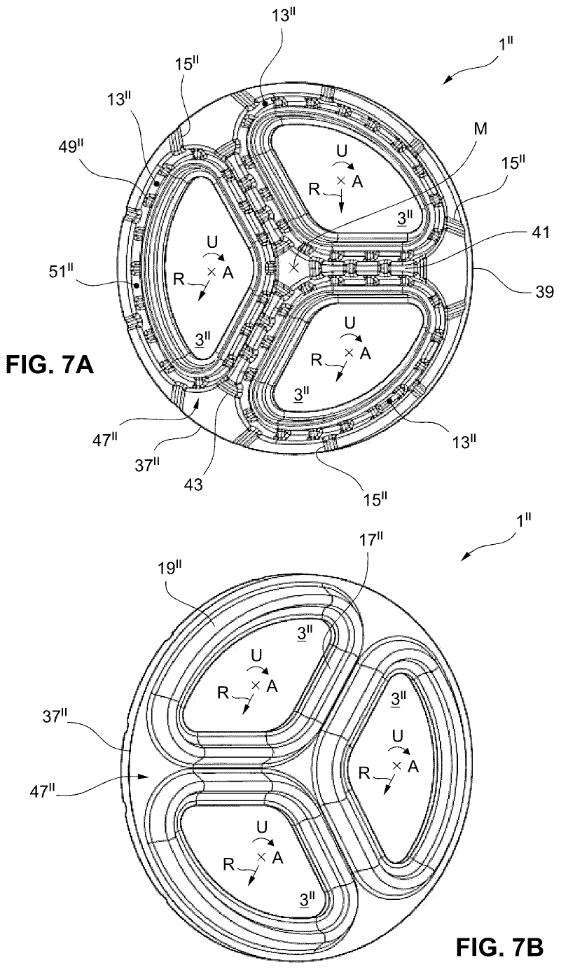

FIGS. 1A to 1C show different views of an embodiment of a seal 1 according to the disclosure with a circular fluid passage opening 3. FIGS. 6A and 6B show different views of an alternative embodiment of a seal 1′ according to the disclosure with an oval fluid passage opening 3′; the seals 1 and 1′ are curved in order to be able to form sealing contact between cylindrical lateral surfaces 5, 7 of cylindrical rotary slides 9 and housings 11. Such embodiments of seal 1, 1′ can be referred to as a lateral embodiment. FIGS. 7A and 7B show different views of an alternative embodiment of a seal 1″ with three disc-section-shaped fluid passage openings 3″. The seal 1″ is designed to form sealing contact between disk-shaped end faces 5′, 7′ of disk-shaped rotary slides 9″ and cylindrical housings 11″. Such embodiments of seal 1″ can be referred to as end face embodiments. Each of the illustrated seals 1, 1′, 1″ has in each case at least one pressure chamber 13, 13′, 13″ which runs around the respective fluid passage opening 3, 3′, 3″. The seal 1″ correspondingly has three pressure chambers 13″ which run around in each case one of the three fluid passage openings 3″. Each of the seals 1, 1′, 1″ furthermore has a multiplicity of communication channels 15, 15′, 15″ for flooding the respective pressure chambers 13, 13′, 13″ with the fluid.

The respective fluid passage opening 3, 3′, 3″ defines a throughflow direction D in which fluid can flow through the seal in the assembled state with the rotary slide open. The throughflow direction D is the direction which runs parallel to a normal of the respective fluid passage opening. In the embodiments 1, 1′ with a curved fluid passage opening, the fluid passage opening 3, 3′ is to be assumed as an uncurved surface in order to determine the normal, that is to say as a circle in FIGS. 1A to 1C and as an oval shape in FIGS. 6A and 6B. In order to determine the geometry of the seal, an axis which is located in the geometric center of the respective fluid passage opening 3, 3′, 3″ and extends parallel to the throughflow direction is referred to below as central axis A. If reference is made below to the circumferential direction U or radial direction R, these directions each relate to the central axis A.

The respective communication channel 15, 15′, 15″ of the seals 1, 1′, 1″ runs around the fluid passage opening 3, 3′, 3″ completely in the circumferential direction U. In the illustrated embodiments, the geometry of the pressure chamber 13, 13′, 13″ is in each case matched to the geometry of the respective fluid passage opening 3, 3′, 3″. Correspondingly, the seal 1 has an annular pressure chamber 13. The seal 1′ has an oval pressure chamber 13′. The respective pressure chambers 13″ of the seal 1″ have the shape of the disc-section-shaped outer contour of the fluid passage openings 3″. In all the illustrated embodiments, the pressure chambers 13, 13′ and 13″ are formed as a groove made in the sealing material of the respective seal 1, 1′, 1″. In the illustrated embodiments, the grooves taper. In particular, the grooves taper in the axial direction A. In particular, the grooves taper in the axial direction A toward the side of the respective seal 1, 1′, 1″ facing the rotary slides. In the illustrated exemplary embodiments, the grooves are formed in a V shape, in particular in a V shape, in the direction of the side of the respective seal 1, 1′, 1″ facing the rotary slides. Furthermore, the pressure chambers 13, 13′, 13″ are in the present case made in the respective seal 1, 1′, 1″ in such a way that the pressure chambers are open on one side, in particular on the side of the directional control valve facing the housing 11. In particular, the pressure chambers 13, 13′, 13″ are in each case bounded by an inner limb 17, 17′, 17″ facing the respective fluid passage opening 3, 3′, 3″ and an outer limb 19, 19′, 19″ facing away from the fluid passage opening 3, 3′, 3″. As illustrated, the inner limb 17, 17′, 17″ and the outer limb 19, 19′, 19″ may run towards one another, in particular towards one another in the axial direction A, in particular towards one another in the direction of the side of the seal 1, 1′, 1″ facing the rotary slide, in particular towards one another in a V shape. On the side of the seal 1, 1′, 1″ facing the housing 11, 11″, the inner limb 17, 17′, 17″ and the outer limb 19, 19′, 19″ are spaced apart from one another in the radial direction R. In the illustrated exemplary embodiments, the inner limb 17, 17′, 17″ and the outer limb 19, 19′, 19″ are spaced apart from one another on the side facing the housing along the entire course of the pressure chambers 13, 13′, 13″. In particular, the inner limb 17, 17′, 17″ and the outer limb 19, 19′, 19″ run around the fluid passage opening 3, 3′, 3″ and the pressure chamber 13, 13′, 13″ completely in the circumferential direction U. In addition, the outer limb 19, 19′, 19″ runs around the pressure chamber 13, 13′, 13″ completely in the circumferential direction U. As a result of the distance between the respective inner limb 17, 17′, 17″ and the outer limb 19, 19′, 19″ in the radial direction R, a circumferential opening of the pressure chamber 13, 13′, 13″, which opening is annular in particular in the case of seal 1, oval in the case of seal 1′ and disc-section-shaped in the case of seal 1″, is bounded, which opening is closed by the housing 11, 11″ of the rotary slide in the assembled state of the respective seal 1, 1′, 1″. As a result, the respective pressure chamber 13, 13′, 13″, apart from the respective communication channels in the assembled state, is completely enclosed by the sealing material and the housing.

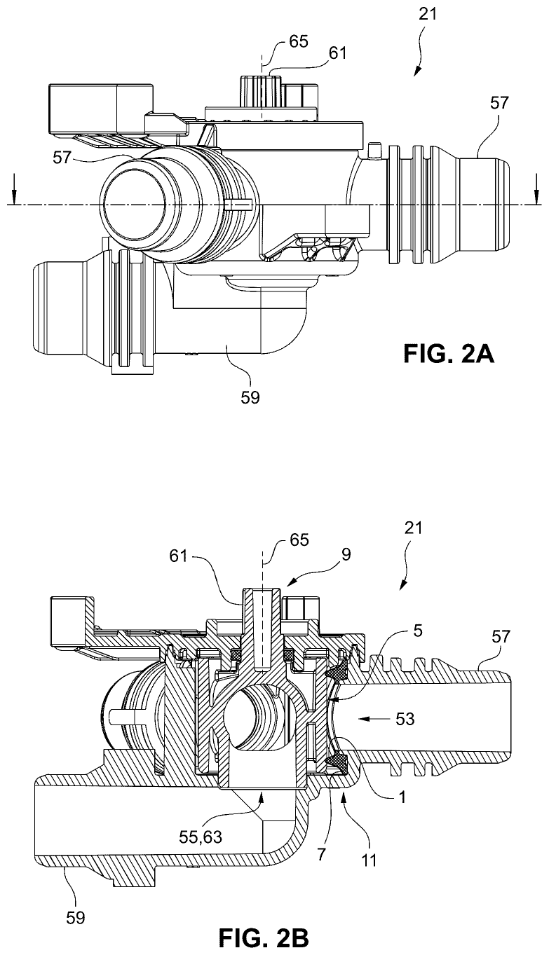

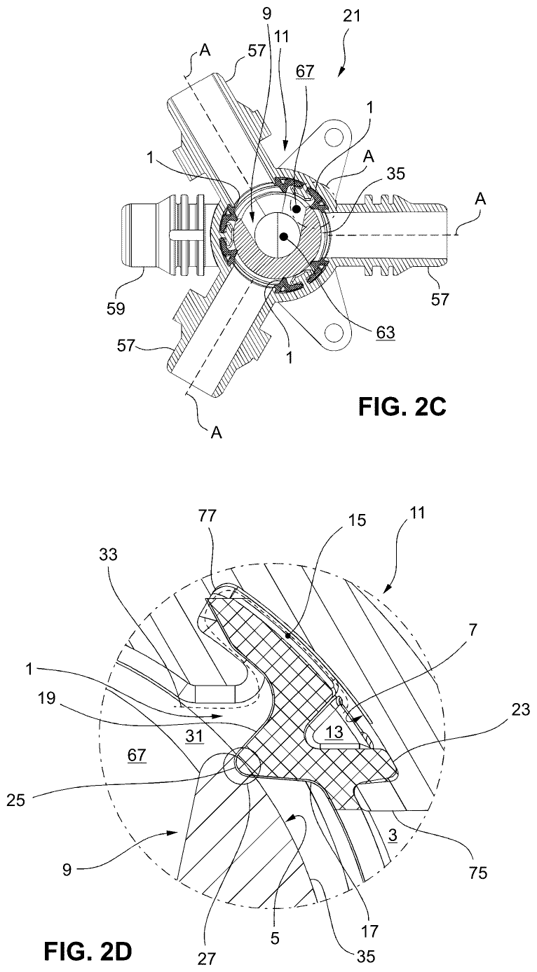

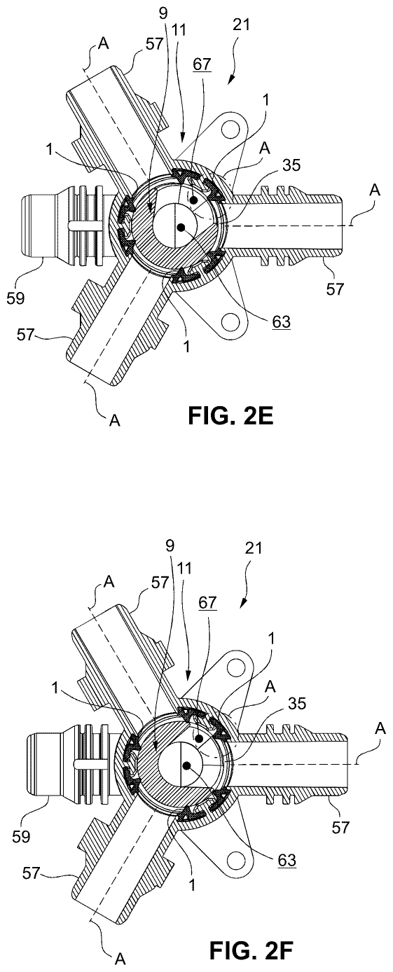

FIG. 2D shows a cross-sectional view of the region A from FIG. 2C of the seal 1 in sealing contact with the rotary slide 9 and the housing 11 of the directional control valve 21 according to FIGS. 2A-2F. As can be seen therein, the inner limb 17 has an outer sealing surface 23 facing the housing 11 and an inner sealing surface 25 facing the rotary slide to form the sealing contact. The outer sealing surface 23 and the inner sealing surface 25 run around the fluid passage opening 3 in the circumferential direction U. In the case of the seal 1, the inner sealing surface 25 and the outer sealing surface 23 run around the fluid passage opening 3 annularly. In the case of the seal 1′, corresponding inner sealing surfaces 25 and outer sealing surfaces 23 run around the fluid passage opening 3′ along an oval contour. In the case of the seal 1″, corresponding inner sealing surfaces 25 and outer sealing surfaces 23 run around the respective fluid passage opening 3″ in a disc-section-shaped manner. As can be seen in particular from the overlap region 27 in FIG. 2D, the seal 1 has an oversize in the axial direction A with respect to the distance between rotary slide 9 and housing 11, in particular between the lateral surface 5 of the rotary slide 9 and the lateral surface 7 of the housing 11. As a result, the seal 1 is compressed in the assembled state, in particular in the axial direction A. A contact force which produces the sealing contact, in particular in the region of the sealing surfaces 23 and 25, is thereby produced. To intensify this sealing contact, a seal 1, 1′, 1″ according to the disclosure has, as described above, communication channels 15 via which the pressure chamber 13, 13′, 13″ can be flooded with fluid. Fluid can thereby pass from an intermediate space 31 between the rotary slide 9 and the housing 11 via the communication channels 15 into the pressure chamber 13. An exemplary flow profile of the fluid from the intermediate space 31 into the pressure chamber 13 (secondary flow) is illustrated schematically by the dashed line 33. The fluid passage opening 3 which can be seen in sections in FIG. 2 d is in a closed position in the illustrated operating state. This is characterized in that a blocking section 35 of the rotary slide 9 forms a surrounding sealing contact with the inner sealing surface 25 and the outer sealing surface 23 forms a surrounding sealing contact with the lateral surface 7 of the housing 11. Fluid flow from the fluid line connected to the fluid passage opening 3 into the intermediate space 31 is avoided by the two surrounding sealing contacts. By flooding the housing 11, in particular the intermediate space 31, for example by one of the other fluid lines of the directional control valve, it can be ensured that a higher fluid pressure can prevail in the pressure chamber 13 than in the side of the inner limb 17 facing the fluid passage opening 3. An overpressure is thereby produced in the pressure chamber, as a result of which the pressure chamber can be inflated. The contact force, in particular with respect to the surrounding sealing surfaces 23 and 25, can thereby be increased, which increases the sealing contact and the tightness of the seal or of the directional control valve. A self-intensifying, fluid-force-assisted seal is thereby provided.

As can be seen from FIG. 2D, the communication channel 15 is connected to the pressure chamber 13 via the outer limb 19. In the assembled state, apart from a communication opening with the pressure chamber 13 and with the intermediate space 31, the communication channel 15 is completely enclosed by the sealing material of the seal 1 and the cylinder lateral surface 7 of the housing 11. In the present case, the communication channel 15 is formed by a groove, in particular a v-shaped groove, in the sealing material of the seal 1, which groove is closed to form a channel by the housing 11, in particular by the cylinder lateral surface 7 of the housing 11, in the assembled state. In alternative embodiments, the at least one communication channel can also be formed, for example, as a bore through the outer limb 19.

The seals 1, 1′, 1″ have a foot 37, 37′, 37″ to be placed on the housing 11. The foot 37, 37′, 37″ may be arranged on the outside of the pressure chamber 13, such as of the outer limb 19, 19′, 19″, in the radial direction R. The foot 37, 37′, 37″ can in particular adjoin the end of the seal 1, 1′, 1″ facing the housing 11 on the outside in the radial direction R and from there, may extend in the radial direction R. The foot 37, 37′, 37″ can completely run around the fluid passage opening 3, 3′ in the circumferential direction U. The foot 37, 37′ can in particular completely run around the pressure chamber 13, 13′ and the outer limb 19, 19′ in the circumferential direction U. In this case, the foot 37, 37′ can be of curved form in order to be able to be placed against a cylinder lateral surface 7 of the housing 11. The foot can have a square outer contour with rounded corners. The foot can in particular, as in the case of the seals 1 and 1′, have a rectangular outer contour with rounded edges. The foot can in particular, as in the case of seal 1, have a square outer contour with rounded edges or, as in the case of seal 1′, a rectangular outer contour with rounded edges with different edge lengths. Alternatively, the foot 37″, as illustrated in the case of the seal 1″, can have an annular shape which runs around the individual fluid passage openings 3″ in sections and runs completely around the arrangement of the plurality of fluid passage openings 3″. Furthermore, in embodiments with a plurality of fluid passage openings 3″, the foot 37″ can, in addition to the outer contour 39, have webs 41 extending to the center point of the seal 1″, which webs in particular separate the individual fluid passage openings 3″ from one another in the circumferential direction (with respect to the center point M). Communication channels 43 which connect the pressure chambers 13″ to one another can be provided in the webs 41. Fluid exchange between the pressure chambers 13″ of the different fluid passage openings 3″ can thereby be ensured.

The communication channels 15, 15′, 15″ may be made in the foot 37, 37′, 37″, in particular made in the form of grooves in the respective foot 37, 37′, 37″. In this case, the communication channels may be formed as v-shaped grooves. The communication channels 15, 15′, 15″ can extend between the foot 37, 37′, 37″ and the housing 11 in the assembled state, in particular be enclosed by the housing and the respective foot.

A seal 1 may include, in each case, a multiplicity of communication channels 15, 15′, 15″ which are arranged offset with respect to one another in particular in the circumferential direction U around the fluid passage opening 3, 3′, 3″, in particular around the pressure chamber 13, 13′, 13″ and/or the outer limb 19, 19′, 19″.

The communication channels 15, 15′, 15″ may extend in the radial direction from the outside inwards through the respective foot 37, 37′, 37″ into the respective pressure chamber 13, 13′, 13″. The respective foot 37, 37′, 37″ may include an effective surface 45 facing the rotary slide 9, via which the fluid pressure in the flooded housing presses the foot against the housing, in order to provide a contact pressure between the foot 37, 37′, 37″ and the housing 11 counteracting a relative movement between the seal 1, 1′, 1″ and the housing 11. The foot 37, 37′, 37″ furthermore may include a bearing surface 47 on the side facing the housing.

The bearing surface 47, 47′, 47″ may be interrupted by the above-described communication channels 15, 15′, 15″, in particular in the case of their embodiment as a groove in the respective foot 37, 37′, 37″. Apart from the interruption by the communication channels 15, 15′, 15″, the bearing surface 47, 47′, 47″ may correspond substantially to the effective surface 45, 45′, 45″. Substantially is to be understood here as meaning a deviation of, in particular, at most 20%, 15% or 10%. With additional consideration of the interruption of the bearing surface 47, 47′, 47″ by the communication channels 15, 15′, 15″, the bearing surface may be at least 40%, 50% or 60% and/or at most 90%, 80% or 70% of the effective surface 45, 45′, 45″.

A multiplicity of support ribs 49, 49′, 49″ are in each case provided in the respective pressure chambers 13, 13′, 13″ in the seals 1, 1′, 1″. The support ribs 49, 49′, 49″ divide the respective pressure chamber 13, 13′, 13″ into chamber sections 51, 51′, 51″ between which fluid exchange is possible. For this purpose, the support ribs 49, 49′, 49″ may be configured such that they do not extend completely in the axial direction as far as the ends of the above-described limbs facing the housing in order to form a through-flow cross section between the respective support ribs 49 and the housing 11, in particular the cylinder lateral surface 7 of the housing 11. The support ribs 49, 49′, 49″ may extend in the radial direction between the above-described inner limb 17, 17′, 17″ and outer limb 19, 19′, 19″. In particular, the support ribs 49, 49′, 49″ may be arranged distributed in the circumferential direction U, in particular at equidistant distances, around the fluid passage opening 3, 3′, 3″ and spaced apart from one another in the respective pressure chamber 13, 13′, 13″.

FIGS. 2A to 2F show different views of an embodiment of a four-way valve 21 for adjusting the flow of a fluid, such as a coolant. The four-way valve 21 may comprise a housing 11 with four fluid passage openings 53, 55. The housing is of cylindrical form. Three fluid passage openings 53 are attached in the casing of the housing. The three fluid passage openings 53 introduced in the casing are arranged offset with respect to one another in the circumferential direction U (with respect to the axis of symmetry of the cylindrical housing), in particular in each case arranged offset with respect to one another by 120°. The fluid passage openings 53 are introduced as circular cutouts in the casing of the housing 11. The fourth fluid passage opening 55 of the housing 11 is made on the end side of the housing 11. The fluid passage opening 55 is likewise of circular form. The four-way valve 21 furthermore has in each case one fluid line 57, 59 connected to each of the fluid passage openings 53, 55. The fluid lines 57, 59 are each of hollow cylindrical form. The fluid lines 57 adjoin the fluid passage openings 53. The fluid line 59 adjoins the fluid passage opening 55. The fluid lines 57 are arranged offset with respect to one another in the circumferential direction (with respect to the axis of symmetry of the cylindrical housing 11), in particular at equidistant distances from one another. In particular, the fluid lines are arranged star-shaped with respect to one another. The fluid line 59 is arranged offset with respect to the fluid lines 57 in the axial direction (parallel to the axis of symmetry of the cylindrical housing 11).

The four-way valve 21 furthermore has a rotary slide 9 arranged in the housing 11. The rotary slide 9 is of cylindrical form. The outer diameter of the rotary slide 9 is smaller than the inner diameter of the housing 11, with the result that a movement play is present between the rotary slide 9 and the housing 11. A seal 1, as illustrated in FIGS. 1A-1C, is arranged in each case between the rotary slide 9 and the fluid lines 57 and is in sealing contact with the rotary slide 9 and the housing 11. Here, the seals 1 run around in each case one of the three fluid passage openings 53. Here, the fluid passage openings 53 of the seals 1 are in each case aligned with the fluid passage openings 53 in the housing 11. The rotary slide 9 is arranged rotatably in the housing 11. The rotary slide 9 has a drive journal 61, via which the rotary slide can be adjusted via a drive, in particular via a motor, such as an electric motor. The rotary slide 9 has, on its side facing the fluid passage opening 55, a fluid passage opening 63 which is aligned with the fluid passage opening 55 of the housing. The fluid passage opening 63 is arranged coaxially with respect to the axis of rotation 65 of the rotary slide 9. In particular, the fluid passage opening 63 is of circular form and is arranged coaxially with respect to the fluid passage opening 55 in the housing. With the illustrated rotary slide 9, the fluid passage opening 63 is always switched actively, in particular in such a way that, independently of the position of the rotary slide, fluid exchange between the rotary slide 9 and the fluid line 59 is always permitted. The rotary slide 9 furthermore has a second fluid passage opening 67 which is made in the casing of the rotary slide 9. The fluid passage opening 67 is connected to the fluid passage opening 63, with the result that fluid which enters into the rotary slide via the fluid passage opening 63 can leave the rotary slide via the fluid passage opening 67. In other words, the rotary slide 9 is designed in such a way that fluid can enter into the rotary slide via the end side thereof and can exit via openings in the casing and vice versa. As can be seen in particular from FIGS. 2C, 2E and 2F, the fluid passage opening 67 is of larger design than the fluid passage openings 53 of the housing 11 and of the fluid lines 57. As a result, the fluid line 59 for a primary flow can be connected to one of the fluid lines 57 and a secondary flow from one of the fluid lines 57 or 59 can simultaneously be permitted via the intermediate space 31 between rotary slide 9 and housing 11 (cf. FIG. 2C and FIG. 2F). Furthermore, the fluid passage opening 67 in this exemplary embodiment is of such a large design that two of the fluid lines 57 can be connected to the fluid line 59 simultaneously. As a result, for example, fluid flows from two lines can be guided into one line or a fluid flow from one line can be divided into two lines. For this purpose, in the present case, the fluid passage opening 67 is of larger design in the circumferential direction (with respect to the axis of symmetry of the cylindrical rotary slide) than the distance between two fluid lines 57 with respect to one another in the circumferential direction. The directional control valve 21 is correspondingly designed to flood the housing 11, in particular the intermediate space 31 between the housing 11 and the rotary slide 9.

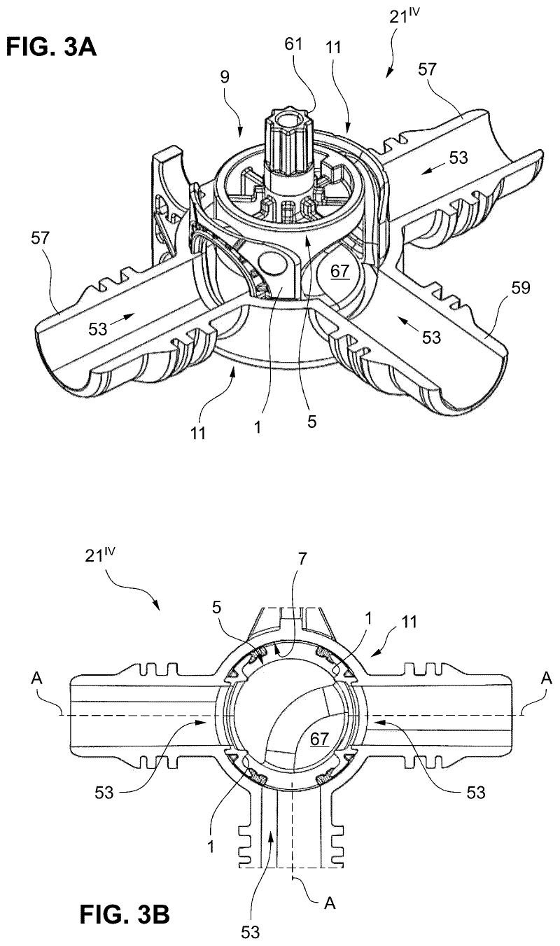

FIGS. 3A and 3B show an embodiment of a three-way valve 21iv. The three-way valve 21^{iv} is very similar to the four-way valve 21, with the result that in particular the differences thereof will be discussed below. The three-way valve 21^{iv} has three fluid lines 57 which are connected to fluid passage openings 53 made in the cylindrical housing 11. The fluid lines 57 are arranged offset with respect to one another in the circumferential direction (with respect to the axis of symmetry of the cylindrical housing 11) by in each case 90°. A seal 1 according to the disclosure is arranged in each case between the housing 11 and the rotary slide 9 at two fluid passage openings 53, in particular at fluid passage openings 53 which are aligned with one another. The third fluid passage opening 59 is designed free from a seal. As a result, independently of the position of the rotary slide 9, fluid can flow via the fluid line 59 into the intermediate space between rotary slide 9 and housing 11, and a secondary fluid flow can thus be permitted for flooding the pressure chambers 13, 13′, 13″. A fluid passage opening is made in the rotary slide 9 and extends into the rotary slide 9 over approximately 90° in the circumferential direction with respect to the casing of the rotary slide 9. In particular, the fluid passage opening 67 of the rotary slide 11 is designed in the form of a circular segment in the axial direction (with respect to the axis of rotation of the rotary slide 9).

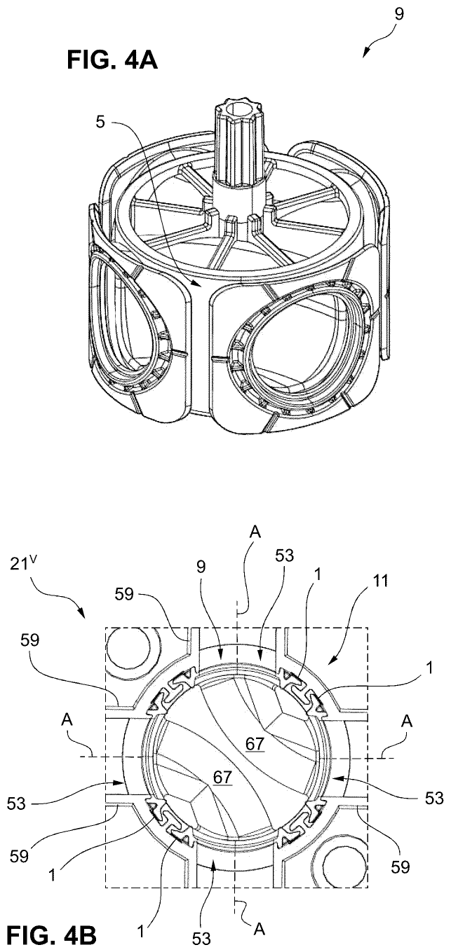

FIGS. 4A and 4B show an alternative embodiment of a four-way valve v with four fluid passage openings 53 arranged offset with respect to one another in the circumferential direction (with respect to the axis of symmetry of the cylindrical housing 11) and fluid lines 59 connected to these. In each case one fluid line 59 is aligned with a fluid passage opening 53 of the housing. The fluid passage openings 53 are offset with respect to one another by 90° in the circumferential direction. The rotary slide 9 for its part has two fluid passage openings 67 which extend in the circumferential direction in each case over 90° of the casing of the rotary slide 9. As a result, two pairs of fluid lines 59 can be connected to one another independently of one another. A seal 1 is arranged in each case between the rotary slide 9 and the housing 11 at each of the fluid passage openings 53.

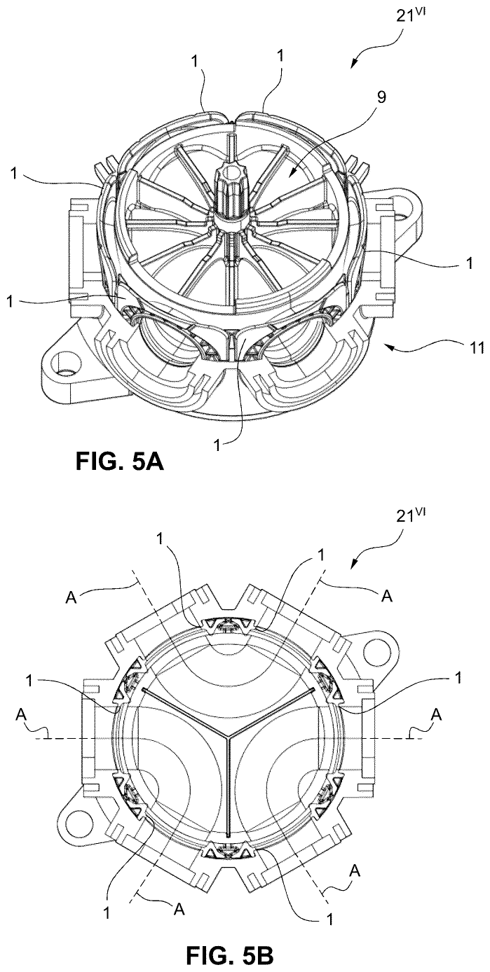

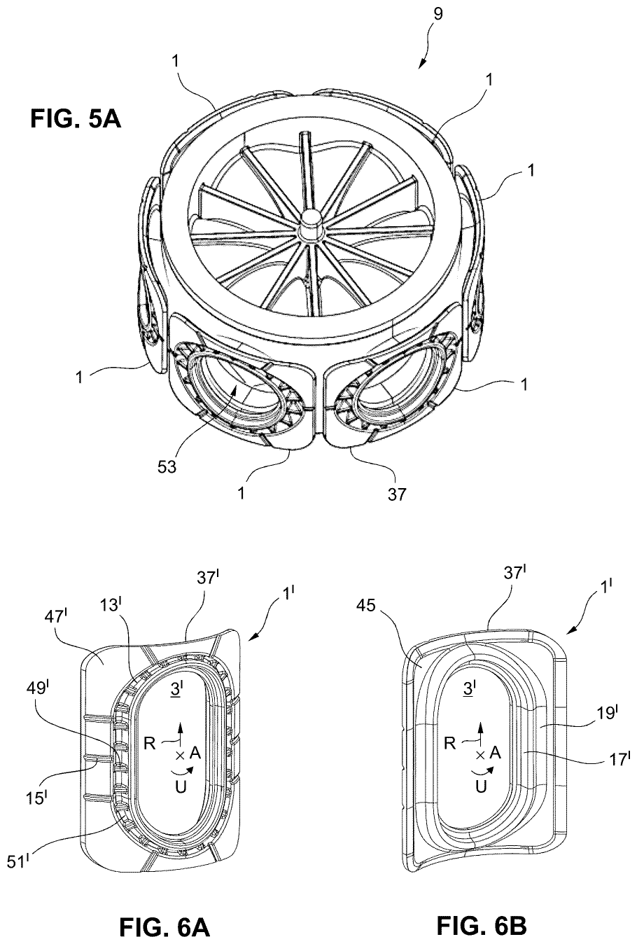

FIGS. 5A-5C show an embodiment of a directional valve vi with six fluid passage openings arranged offset with respect to one another in the circumferential direction (with respect to the axis of symmetry of the cylindrical housing 11). FIG. 5C shows an embodiment of a rotary slide 9 with six fluid passage openings 53 which are arranged offset with respect to one another in the circumferential direction (with respect to the axis of symmetry of the cylindrical rotary slide 9), in particular are arranged at equidistant distances from one another, in particular are made in the casing of the cylindrical rotary slide 9. A seal 1 according to FIGS. 1A-1C is attached to each of the six fluid passage openings 53.

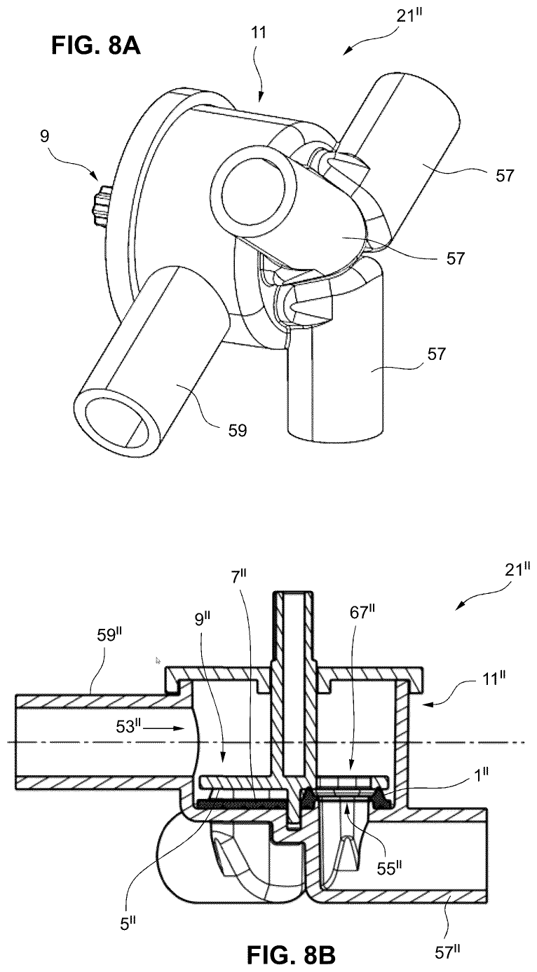

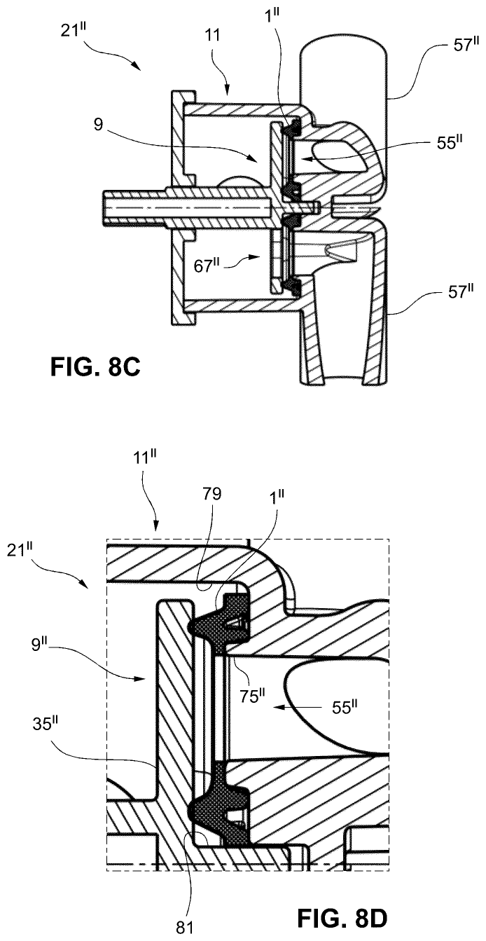

FIGS. 8A-8D show different views, sectional illustrations and enlarged views of an embodiment of a four-way valve in which four fluid lines 57″, 59″ are connected to the housing 11. Three of the fluid lines 57 adjoin the cylindrical housing 11 via the end side thereof. For this purpose, three fluid passage openings 55′ which are arranged offset with respect to one another in the circumferential direction (with respect to the axis of symmetry of the cylindrical housing 11), in particular in each case arranged offset with respect to one another by 120°, are provided in the end side. A disk-shaped rotary slide 9″ is provided to close off and open up the fluid passage openings 55″. Fluid passage openings 67″ which can be arranged in alignment with the fluid passage openings 55″ in order to expose the fluid passage openings 55″ by adjusting the rotary slide 9″ are provided in the disk-shaped rotary slide 9″. To block off the fluid passage openings 55″, the rotary slide 9″ has blocking sections 35″. The housing furthermore has a fluid passage opening 53″ which is made in the casing of the housing 11″ and to which a fluid line 59″ is connected. cylindrical intermediate space which can be flooded with the fluid which is set by the directional control valve is provided between the disk-shaped rotary slide 9″ and the cylindrical housing 11″. One or more primary fluid flows between the fluid lines 57″ and 59″ can be connected to one another via the intermediate space 31″, and one or more secondary fluid flows can flow via the respective communication channels 15″ into the pressure chambers 13″ of the seal 1″ according to FIGS. 7A and 7B. The seal 1″ is arranged between the disk-shaped rotary slide 9″ and the end side of the housing 11″.

As described above, according to one aspect of the disclosure, the housings 11, 11″ have a support structure 75, 75″ in the connection region between the respective fluid passage openings 53, 55″, which support structure counteracts slipping of the respective seal 1, 1″ into the fluid passage opening 53, 55″. For this purpose, the support structure 75, 75″ may be formed as a collar running around the fluid passage opening 53, 55″. The support structure 75″ can in particular be formed as a structure, in particular annular structure, projecting inwards into the housing with respect to the surfaces of the housing 11, 11″ with which the seal 1, 1″ are in sealing contact.

The directional control valve furthermore may include, in addition to the above-described support structure, which can also be referred to as an inner support structure 75, 75″, an outer support structure 77, 79, 81. As can be seen, for example, from FIG. 2D, the outer support structure 77 can be designed as a recess 77 formed in the housing 11, into which recess 77 the foot 37, 37′, 37″ of the seal 1 projects. It can thereby be ensured, in particular, that as a result of overpressure forming in the pressure chamber 13, the expansion produced thereby does not lead to spreading of the inner limb 17 and outer limb 19, but rather to inflation of the pressure chamber 13 in the axial direction A, which inflation intensifies the sealing contact, in particular in the region of the sealing surfaces 23, 25. FIG. 8D shows an alternative embodiment of the outer support structure 79, 81. In this case, the depression formed in the lateral surface 79 of the housing, on the one hand, and a pin 81 of the rotary slide, on the other hand, can function as an outer stop 79, 81.

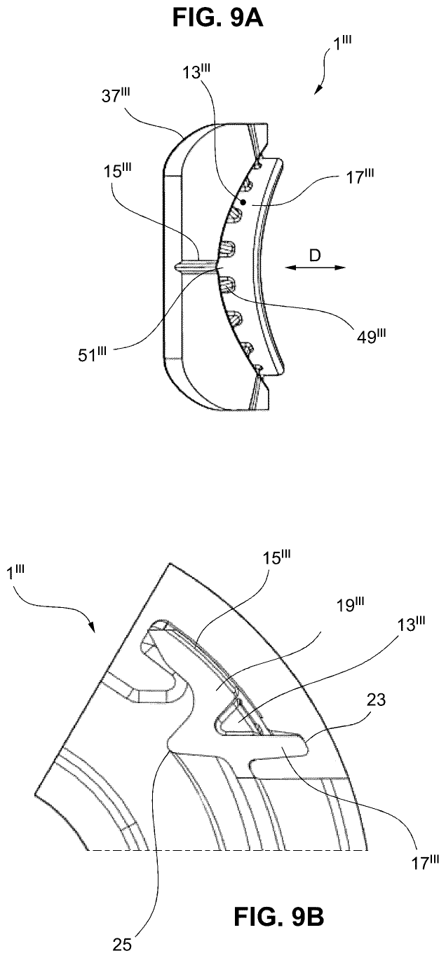

FIGS. 9A and 9B show a further exemplary embodiment of a seal 1″ according to the disclosure. The seal 1″ differs from the seal 1 in FIGS. 1A-1C in that, on the side of the seal 1″ facing the housing, the inner limb 17′″ is longer than the outer limb 19′″. An annular groove which is matched to the longer inner limb 17′″ can be formed in the housing 11 (not illustrated in FIGS. 9A and 9B), in which annular groove the inner limb 17′″ is received in an accurately fitting manner in the mounted state of the seal 1′″. The inner limb 17″ can be received in the groove via a “tongue-and-groove” principle. In this embodiment, the seal 1″ can provide improved seal in both directions of action of the pressure.

The features disclosed in the preceding description, the figures and the claims can be significant both individually and in any desired combination for the implementation of the disclosure in the various configurations.

### LIST OF REFERENCE SIGNS

1, 1′, 1″, 1′″ seal
3, 3′, 3″, 3′″ fluid passage opening
5 lateral surface of the rotary slide
7 lateral surface of the housing
9, 9″ rotary slide
11, 11″ housing
13, 13′, 13″, 13′″ pressure chamber
15, 15′, 15″, 15′″ communication channel
17, 17′, 17″, 17′″ inner limb
19, 19′, 19″, 19′″ outer limb
21, 21′, 21″, 21′″ directional control valve
23 outer sealing surface
25 inner sealing surface
27 overlap region
31, 31″ intermediate space
33 secondary fluid flow
35, 35′, 35″ blocking section
37, 37′, 37″, 37′″ foot
39 outer contour
41 web
43 communication channel
45, 45′, 45″ effective surface
47, 47′, 47″ bearing surface
49, 49′, 49″, 49″ supporting ribs
51, 51′, 51″, 51″ chamber sections
53, 53″ fluid passage opening
55, 55″ fluid passage opening
57, 57″ fluid line
59, 59″ fluid line
61 drive journal
63 fluid passage opening
65 axis of rotation of the rotary slide
67, 67″ fluid passage opening
75, 75″ inner support structure
77 outer support structure
79 lateral surface of the housing/outer support structure
81 pin/outer support structure
D Throughflow direction
A Central axis
U Circumferential direction
R Radial direction

1. A seal adapted to form for a sealing contact with a housing and a rotary slide, arranged in the housing, of a directional control valve for adjusting a flow of a fluid, the seal comprising:
a pressure chamber; and
at least one communication channel configured to flood the pressure chamber with the fluid.

2. The seal according to claim 1, wherein the pressure chamber runs around a fluid passage opening of the seal.

3. The seal according to claim 2, wherein the pressure chamber is bounded by an inner limb facing the fluid passage opening and an outer limb facing away from the fluid passage opening.

4. The seal according to claim 3, wherein the at least one communication channel is connected to the pressure chamber via the outer limb.

5. The seal according to claim 3, wherein the inner limb comprises an outer sealing surface facing the housing and an inner sealing surface facing the rotary slide to form the sealing contact, wherein the inner sealing surface and/or the outer sealing surface run around the fluid passage opening.

6. The seal according to claim 1, wherein the pressure chamber is configured to taper from a side of the seal facing the housing to a side of the seal facing the rotary slide.

7. The seal according to claim 1, further comprising an outer sealing surface facing the housing and an inner sealing surface facing the rotary slide to form the sealing contact, which are formed from the same material.

8. The seal according to claim 1, further comprising a foot configured to be placed on the housing with an effective surface facing the rotary slide, via which a fluid pressure presses the foot against the housing in response to the housing being flooded with the fluid to provide a contact pressure between the foot and the housing counteracting a relative movement between the seal and the housing.

9. The seal according to claim 8, wherein the at least one communication channel extends between the foot and the housing in an assembled state.

10. The seal according to claim 1, further comprising at least one support rib arranged in the pressure chamber and configured to stabilize the pressure chamber against pressure acting on the pressure chamber from outside the pressure chamber.

11. The seal according to claim 1, wherein the at least one communication channel is configured to fluidically connect the pressure chamber to an intermediate space between the housing and the rotary slide.

12. A directional control valve adapted to adjust a flow of a fluid, comprising:
a housing with a fluid passage opening,
a fluid line connected to the fluid passage opening,
a rotary slide arranged in the housing, and
a seal configured to be in sealing contact with the housing and the rotary slide and surrounding the fluid passage opening.

13. The directional control valve according to claim 12, wherein the seal comprises a support structure arranged in a connection region between the fluid passage opening and the fluid line, wherein the support structure is configured to counteract a slipping of the seal into the fluid passage opening.

14. The directional control valve according to claim 13, wherein the support structure is configured to run around the fluid passage opening to form a collar.

15. The directional control valve according to claim 12, wherein an outer support structure on which an end of the seal facing away from the fluid passage opening is supported.

16. The directional control valve according to claim 12, wherein the directional control valve is configured to flood the housing, including an intermediate space between the housing and the directional control valve.

17. The directional control valve according to claim 12, wherein the rotary slide comprises at least one fluid passage opening configured to allow for the fluid to flow into and out of the rotary slide, wherein the fluid passage opening of the rotary slide is larger than the fluid passage opening of the housing and/or of the seal.

18. A motor vehicle fluid flow guiding system, comprising a directional control valve according to claim 12.

19. The motor vehicle fluid flow guiding system according to claim 18, further comprising a line system connected to the directional control valve.

20. The directional control valve according to claim 12, wherein the seal comprises a pressure chamber; and at least one communication channel configured to flood the pressure chamber with the fluid.
